(19) United States
(12) Patent Application Publication
(10) Pub. No.: US 2024/0144170 A1
(43) Pub. Date: May 2, 2024

(54) Devices and Methods for Computer Vision Guided Planogram Generation

(71) Applicant: ZEBRA TECHNOLOGIES CORPORATION, Lincolnshire, IL (US)

(72) Inventors: Eunhyang Kim, London (GB); Andrea Mirabile, London (GB)

(21) Appl. No.: 17/976,219

(22) Filed: Oct. 28, 2022

(51) Int. Cl. G06Q 10/087; G06V 20/50

(52) U.S. Cl. CPC G06Q 10/087; G06V 20/50

(57) ABSTRACT

Devices and methods for planogram generation are disclosed herein. The method detects at least one first item and at least one label present in a captured image and associates the at least one first item with the at least one label based on a boundary between the at least one first item and at least one second item different from the at least one first item. The method identifies the at least one first item based on at least one attribute of the at least one first item and determines an area indicative of a position of the identified at least one first item based on the association. The area can be one or more of an aisle, a module, a shelf, a rack, a bay, and a bin. The method generates a planogram based on the association, the identified at least one first item and the area.

### BACKGROUND

An associate of a facility (e.g., a retail facility such as a grocery store, convenience store, big box store, etc.) can utilize a planogram to determine a location of each type of item in the facility. By interfacing with customers (e.g., customer service) and/or interacting with items and inventory (e.g., item returns and/or stocking), an associate can learn which items are sought and/or challenging to locate by customers, sell regularly, etc. Generally, a facility planogram is generated by a central entity (e.g., corporate headquarters). Therefore, a planogram may not be facility-specific. For example, the planogram may not reflect customer data (e.g., preferences and trends) and/or facility data (e.g., item returns, inventory, sales, etc.) and a facility may not have the required space (e.g., shelving) to accommodate each item listed on the planogram. As such, an associate may be required to generate a new planogram or modify an existing planogram to reflect customer data and/or facility data and/or accommodate each item. In addition, it can be challenging for an associate to transmit a generated or modified planogram in real-time to the central entity to optimize the generation of a facility-specific planogram.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram illustrating an embodiment of a system of the present disclosure for planogram generation.

FIG. 2 is a diagram illustrating components of the computing device of FIG. 1.

FIG. 3 is a flowchart illustrating processing steps carried out by an embodiment of the present disclosure.

FIGS. 4A-B are diagrams respectively illustrating object detection carried out by an embodiment of the present disclosure.

FIG. 5 is a flowchart illustrating step 306 of FIG. 3 in greater detail.

FIGS. 6A-C are graphs illustrating item and label association carried out by an embodiment of the present disclosure.

FIG. 7 is a diagram illustrating step 334 of FIG. 5.

FIG. 8 is a diagram illustrating item and label association carried out by an embodiment of the present disclosure.

FIG. 9 is a flowchart illustrating step 308 of FIG. 3 in greater detail.

FIG. 10 is a diagram illustrating item identification carried out by an embodiment of the present disclosure.

FIG. 11 is a diagram illustrating item identification carried out by an embodiment of the present disclosure.

FIG. 12 is a diagram illustrating a planogram generated by an embodiment of the present disclosure.

FIG. 13 is a table illustrating a planogram generated by an embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As mentioned above, a facility planogram is generally generated by a central entity (e.g., corporate headquarters). Therefore, a planogram may not be facility-specific. For example, the planogram may not reflect customer data (e.g., preferences and trends) and/or facility data (e.g., item returns, inventory, sales, etc.) and a facility may not have the required space (e.g., shelving) to accommodate each item listed on the planogram. As such, an associate may be required to generate a new planogram or modify an existing planogram to reflect customer data and/or facility data and/or accommodate each item. Conventional planogram generation and/or modification systems can be manual (e.g., rely on human intervention) and, as such, can be time-consuming, cost-prohibitive (e.g., associate labor costs), and subject to human error. These systems can also require imaging systems (e.g., high-resolution camera systems) that are cost-prohibitive to deploy and utilize in a facility. In addition, it can be challenging for an associate to transmit a generated or modified planogram in real-time to the central entity to optimize the generation of a facility-specific planogram. For example, the planogram may be a modified hard copy such that the modified planogram may not readily be transmitted in real-time.

As such, conventional planogram systems suffer from a general lack of versatility because these systems cannot automatically and dynamically generate a planogram based on an association between at least one first item and at least one label, an identification (e.g., a stock keeping unit (SKU) and/or product code such as a universal product code (UPC)) of the at least one first item, and an area indicative of a position of the identified at least one first item. Overall, this lack of versatility causes conventional planogram systems to provide underwhelming performance and reduce the efficiency and general timeliness of generating and/or modifying and/or transmitting planograms. Thus, it is an objective of the present disclosure to eliminate these and other problems with conventional planogram systems and methods via systems and methods that can automatically and dynamically detect at least one first item and at least one label present in a captured image; associate the at least one first item with the at least one label based on a boundary between the at least one first item and at least one second item different from the at least one first item; identify the at least one first item based on at least one attribute of the at least one first item; determine an area indicative of a position of the identified at least one first item based on the association; and generate a planogram based on the association, the identified at least one first item and the area.

In accordance with the above, and with the disclosure herein, the present disclosure includes improvements in computer functionality or in improvements to other technologies at least because the present disclosure describes that, e.g., information systems, and their related various components, may be improved or enhanced with the disclosed dynamic system features and methods that provide more efficient workflows for workers and improved monitoring and management of planograms for system administrators. That is, the present disclosure describes improvements in the functioning of an information system itself or “any other technology or technical field” (e.g., the field of distributed and/or commercial information systems). For example, the disclosed dynamic system features and methods improve and enhance the generation and/or modification of planograms based on an association between at least one first item and at least one label, an identification (e.g., a SKU and/or product code such as a UPC) of the at least one first item, and an area indicative of a position of the identified at least one first item to mitigate (if not eliminate) worker error and eliminate inefficiencies typically experienced over time by systems lacking such features and methods. This improves the state of the art at least because such previous systems are inefficient as they lack the ability to automatically and dynamically generate and/or modify planograms and/or transmit these planograms in real-time to a central entity to optimize the generation of a facility-specific planogram.

In addition, the present disclosure applies various features and functionality, as described herein, with, or by use of, a particular machine, e.g., a processor, a mobile device (e.g., a tablet, a mobile computer, or wearable) and/or other hardware components as described herein. Moreover, the present disclosure includes specific features other than what is well-understood, routine, conventional activity in the field, or adding unconventional steps that demonstrate, in various embodiments, particular useful applications, e.g., determining an area indicative of a position of the identified at least one first item based on an association between at least one first item and at least one label in connection with generating a planogram. Accordingly, it would be highly beneficial to develop a system and method that can automatically and dynamically generate a planogram based on an association between at least one first item and at least one label, an identification (e.g., a SKU and/or product code such as a UPC) of the at least one first item, and an area indicative of a position of the identified at least one first item. The devices and methods of the present disclosure address these and other needs.

In an embodiment, the present disclosure is directed to a method for planogram generation. The method comprises detecting at least one first item and at least one label present in a captured image; associating the at least one first item with the at least one label based on a boundary between the at least one first item and at least one second item different from the at least one first item; identifying the at least one first item based on at least one attribute of the at least one first item; determining an area indicative of a position of the identified at least one first item based on the association; and generating a planogram based on the association, the identified at least one first item and the area.

In an embodiment, the present disclosure is directed to a device for planogram generation. The device comprises an imaging assembly configured to capture an image featuring a plurality of items, one or more processors, and a non-transitory computer-readable memory coupled to the imaging assembly and the one or more processors. The memory stores instructions thereon that, when executed by the one or more processors, cause the one or more processors to: detect at least one first item and at least one label present in a captured image; associate the at least one first item with the at least one label based on a boundary between the at least one first item and at least one second item different from the at least one first item; identify the at least one first item based on at least one attribute of the at least one first item; determine an area indicative of a position of the identified at least one first item based on the association; and generate a planogram based on the association, the identified at least one first item and the area.

In an embodiment, the present disclosure is directed to a tangible machine-readable medium comprising instructions for instructions for planogram generation that, when executed, cause a machine to at least: detect at least one first item and at least one label present in a captured image; associate the at least one first item with the at least one label based on a boundary between the at least one first item and at least one second item different from the at least one first item; identify the at least one first item based on at least one attribute of the at least one first item; determine an area indicative of a position of the identified at least one first item based on the association; and generate a planogram based on the association, the identified at least one first item and the area.

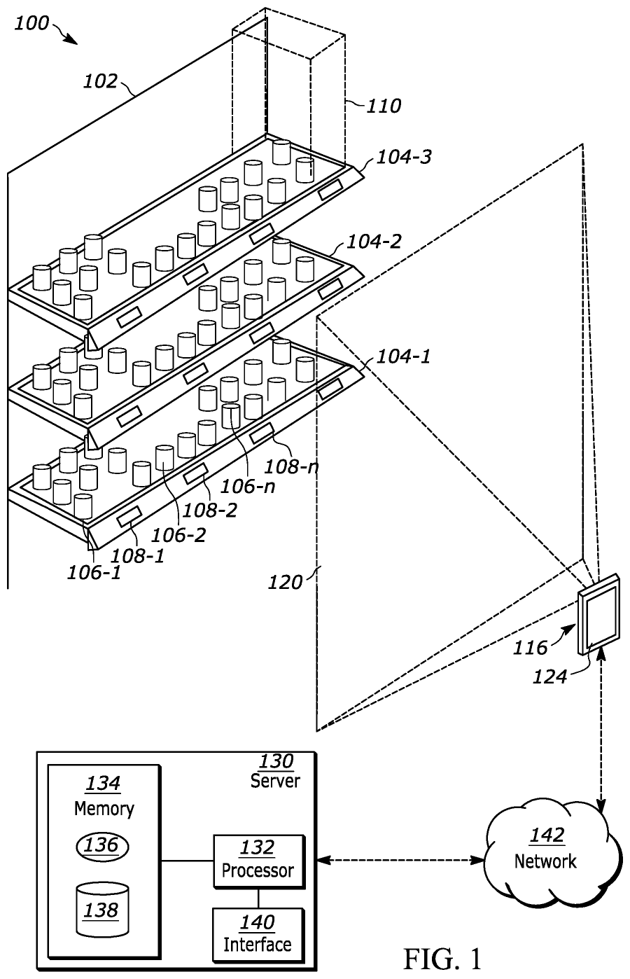

Turning to the Drawings, FIG. 1 is a diagram 100 illustrating an embodiment of a system of the present disclosure. FIG. 1 illustrates a system for dynamic planogram generation. The system can be deployed in a facility (e.g., a grocery store, convenience store, big box store, etc.). For example, the system can be deployed in a customer-accessible portion of the facility that may be referred to as the front of the facility.

Items received at the facility, e.g. via a receiving bay or the like, are generally placed on support structures such as shelves in the stock room, until restocking of the relevant items is required in the front of the facility. An associate can retrieve the items requiring restocking from the back room, and transport those items to the appropriate locations in the front of the facility. Locations for items in the front of the facility are typically predetermined, e.g. according to a planogram that specifies, for each portion of shelving or other support structures, which items are to be placed on such structures. The planogram can be accessed from a mobile device operated by the associate, kept on a printed sheet or the like.

As mentioned above, a facility planogram is generally generated by a central entity (e.g., corporate headquarters). Therefore, a planogram is generally not facility-specific. For example, the planogram may not reflect customer data (e.g., preferences and trends) and/or facility data (e.g., item returns, inventory, sales, etc.) and a facility may not have the required space (e.g., shelving) to accommodate each item listed on the planogram. As such, an associate may be required to generate a new planogram or modify an existing planogram to reflect customer data and/or facility data and/or accommodate each item. For example, if a planogram does not accommodate an item, an associate can generate a new planogram or modify an existing planogram to include an area of the shelving associated with the item. The system provides for generating and/or modifying a planogram based on an association between at least one first item and at least one label, an identification (e.g., a SKU and/or product code such as a UPC) of the at least one first item, and an area indicative of a position of the identified at least one first item.

As shown in FIG. 1, the facility includes at least one support structure such as a display module 102 with one or more support surfaces 104-1, 104-2, and 104-3 (collectively referred to as support surfaces 104, and generically referred to as support surface 104) carrying items 106-1, 106-2, and 106-n (collectively referred to as items 106, and generically referred to as item 106). The items 106 may be of different types such that item 106-1 is different from items 106-2 and 106-n, item 106-2 is different from item 106-n, etc. In addition, an item 106 can comprise one or more items. For example, item 106-1 comprises a group of eight items 106-1 and item 106-2 comprises a group of three items 106-2. Items 106-1, 106-2 and 106-3 can be respectively identified by item labels 108-1, 108-2 and 108-n (collectively referred to as labels 108, and generically referred to as label 108). For example, the label 108 can be a SKU and/or product code (e.g. a UPC) or the like. A planogram can specify an item area 110 (e.g., of a support surface 104) indicative of a position of an item 106. An item area 110 can be determined relative to an alignment of a label 108 (e.g., left, right or center-aligned). As described in further detail below, this can be problematic because these alignments can be inconsistent across a display module 102. For example, one item area 110 can be left aligned with one label 108 while another item area 110 can be center aligned with another label 108.

The system can include a mobile computing device 116, such as a smart phone, a tablet computer, or the like. The device 116 can be operated by an associate at the facility, and includes an imaging assembly (e.g., a camera) having a field of view (FOV) 120 and a display 124. The device 116 can be manipulated such that the imaging assembly can view at least a portion of the display module 102 within the FOV, and can be configured to capture an image or a stream of images of the display module 102. From such images, the device 116 can detect at least one item 106 and at least one label 108. The device 116 can also extract at least one attribute (e.g., a feature) of an item 106 including, but not limited to, a shape, color, pattern, logo, size, width, length, and height of an item 106.

Certain components of a server 130 are also illustrated in FIG. 1. The server 130 can include a processor 132 (e.g. one or more central processing units (CPUs)), interconnected with a non-transitory computer readable storage medium, such as a memory 134 and an interface 140. The memory 134 includes a combination of volatile memory (e.g. Random Access Memory or RAM) and non-volatile memory (e.g. read only memory or ROM, Electrically Erasable Programmable Read Only Memory or EEPROM, flash memory). The processor 132 and the memory 134 each comprise one or more integrated circuits.

The memory 134 stores computer readable instructions for execution by the processor 132. The memory 134 stores a planogram generation application 136 (also referred to simply as the application 136) which, when executed by the processor 132, configures the processor 132 to perform various functions described below in greater detail and related to detecting at least one item 106 and at least one label 108, associating the at least one item 106 with the at least one label 108, identifying the at least one item 106, determining an area indicative of a position of the identified at least one item 106, and generating a planogram based on the association, the identified at least one item 106 and the determined area. As described below, this functionality can also be executed by the processor 202 of the device 116.

The application 136 may also be implemented as a suite of distinct applications in other examples. Those skilled in the art will appreciate that the functionality implemented by the processor 132 via the execution of the application 136 may also be implemented by one or more specially designed hardware and firmware components, such as field-programmable gate arrays (FPGAs), application-specific integrated circuits (ASICs) and the like in other embodiments. The memory 134 also stores a repository 138 including one or more image datasets of a plurality of items 106.

The server 130 also includes a communications interface 140 enabling the server 130 to communicate with other computing devices, including the device 116, via the network 142. The communications interface 140 includes suitable hardware elements (e.g. transceivers, ports and the like) and corresponding firmware according to the communications technology employed by the network 142.

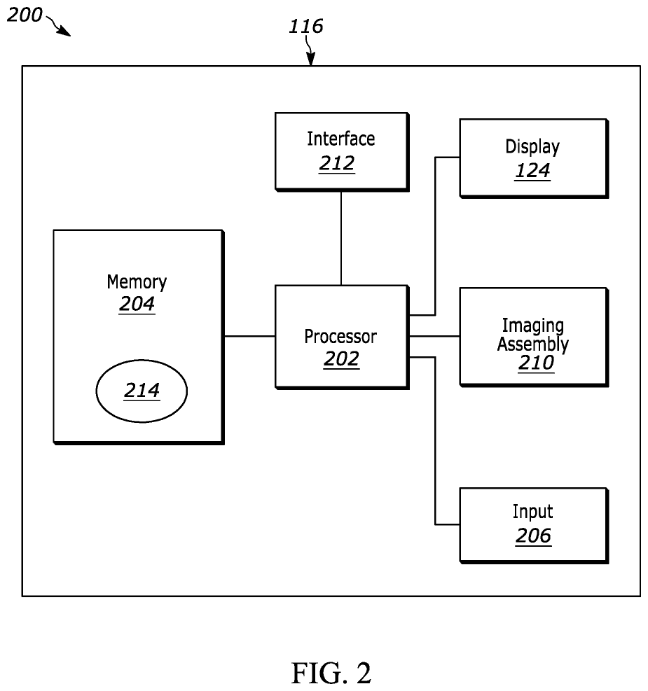

FIG. 2 is a diagram 200 illustrating components of the computing device 116 of FIG. 1. The device 116 includes a processor 202 (e.g. one or more CPUs), interconnected with a non-transitory computer readable storage medium, such as a memory 204, an input 206, a display 124, an imaging assembly 210, and an interface 212. The memory 204 includes a combination of volatile memory (e.g. Random Access Memory or RAM) and non-volatile memory (e.g. read only memory or ROM, Electrically Erasable Programmable Read Only Memory or EEPROM, flash memory). The processor 202 and the memory 204 each comprise one or more integrated circuits.

The at least one input 206 can be a device interconnected with the processor 202. The input device 206 is configured to receive an input (e.g. from an operator of the device 116) and provide data representative of the received input to the processor 202. The input device 206 can include any one of, or a suitable combination of, a touch screen integrated with the display 208, a keypad, a microphone, a barcode scanner and the like. For example, an operator can utilize the barcode scanner to scan a label 108.

The imaging assembly 210 (e.g., a camera) includes a suitable image sensor or combination of image sensors. The camera 210 is configured to capture one or more images for provision to the processor 202 and subsequent processing to detect at least one item 106 and at least one label 108, associate the at least one item 106 with the at least one label 108, identify the at least one item 106, determine an area indicative of a position of the identified at least one item 106, and generate a planogram based on the association, the identified at least one item 106 and the area. As such, the camera 210 need not be a high-resolution camera or a system of high-resolution cameras to decode a label 108 from a captured image because the processor 202 can associate the at least one item 106 with the at least one label 108 and identify the at least one item 106 based on at least one attribute thereof to procure a label 108 (e.g., an identifier such as a SKU or UPC) of the item 106.

In addition to the display 124, the device 116 can also include one or more other output devices, such as a speaker, a notification light-emitting diode (LED), and the like (not shown). The communications interface 212 enables the device 116 to communicate with other computing devices, such as the server 130, via the network 142. The interface 212 therefore includes a suitable combination of hardware elements (e.g. transceivers, antenna elements and the like) and accompanying firmware to enable such communication.

The memory 204 stores computer readable instructions for execution by the processor 202. In particular, the memory 204 stores a planogram generation application 214 (also referred to simply as the application 214) which, when executed by the processor 202, configures the processor 202 to perform various functions discussed below in greater detail and related to detecting at least one item 106 and at least one label 108, associating the at least one item 106 with the at least one label 108, identifying the at least one item 106, determining an area indicative of a position of the identified at least one item 106, and generating a planogram based on the association, the identified at least one item 106 and the area. The application 214 may also be implemented as a suite of distinct applications in other examples. Those skilled in the art will appreciate that the functionality implemented by the processor 202 via the execution of the application 214 may also be implemented by one or more specially designed hardware and firmware components, such as FPGAs, ASICs and the like in other embodiments. As noted above, in some examples the memory 204 can also store the repository 138, rather than the repository 138 being stored at the server 130.

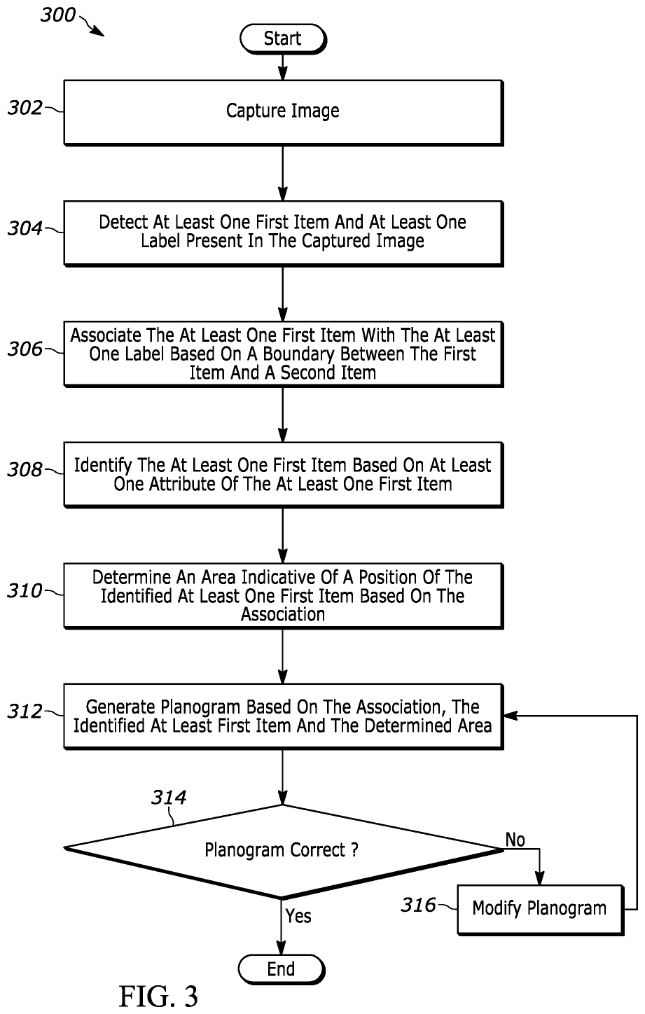

FIG. 3 is a flowchart 300 illustrating processing steps carried out by an embodiment of the present disclosure. The processing steps will be described in conjunction with their performance in the system (e.g., by the computing device 116 or the server 130 in conjunction with the computing device 116). In general, via performance of the processing steps, the system can automatically and dynamically generate a planogram. For example, the system can automatically and dynamically detect at least one item 106 and at least one label 108, associate the at least one item 106 with the at least one label 108, identify the at least one item 106, determine an area indicative of a position of the identified at least one item 106, and generate a planogram based on the association, the identified at least one item 106 and the area.

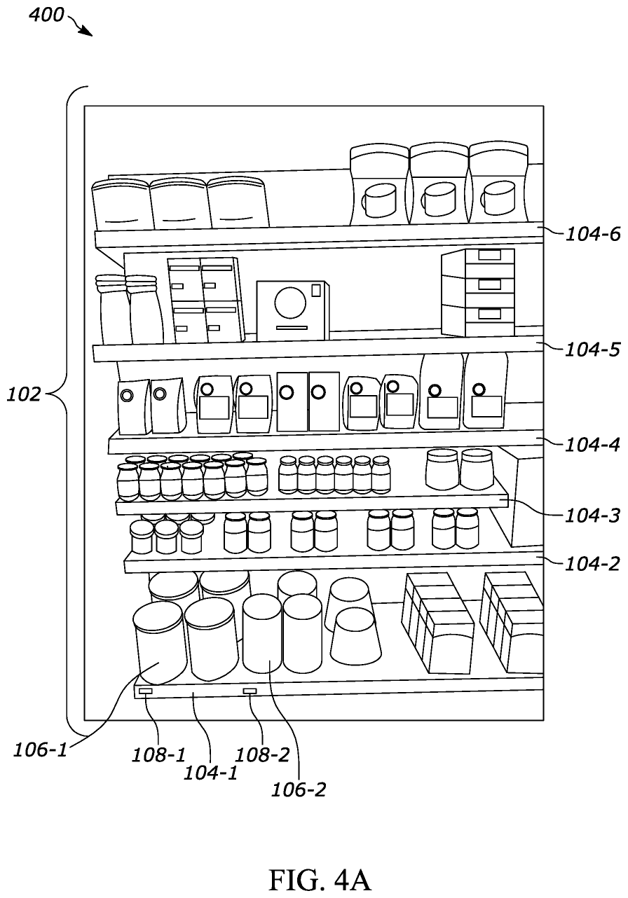

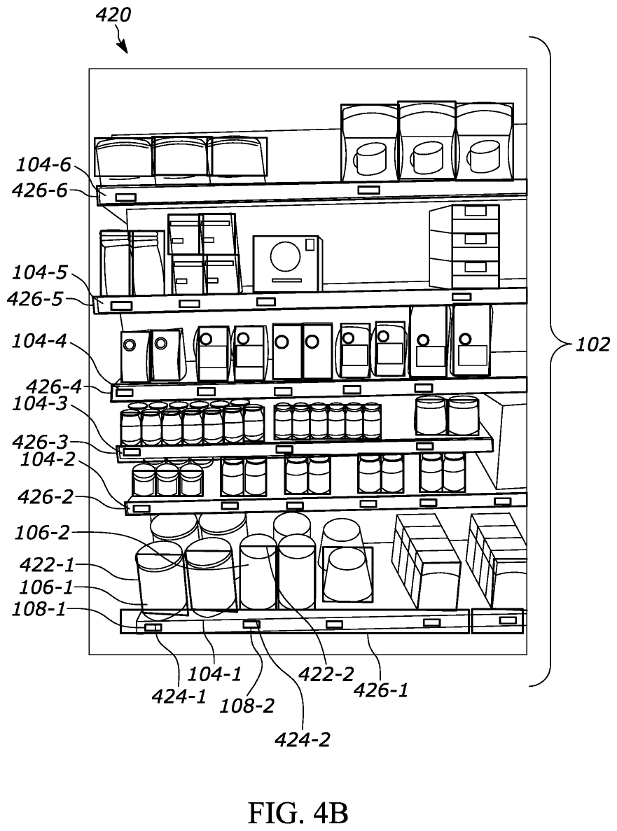

Beginning in step 302, the system captures an image of a display module 102. For example, the system can capture an image via the camera 210 of the device 116 by manipulating the camera 210 such that a FOV of the camera 210 includes at least a portion of the display module 102 including at least one item 106 and at least one label 108. In step 304, the system detects at least one item 106 and at least one label 108 present in the captured image. The system can also detect one or more support surfaces 104 and/or features thereof (e.g., an edge of a support surface 104). For example, the system can utilize a deep neural network (DNN) to detect and localize one or more of a support surface 104, an item 106, and a label 108 via a plurality of boundary boxes. As described in further detail below, FIGS. 4A-B are diagrams respectively illustrating object detection to localize one or more of a support surface 104, an item 106 and a label 108.

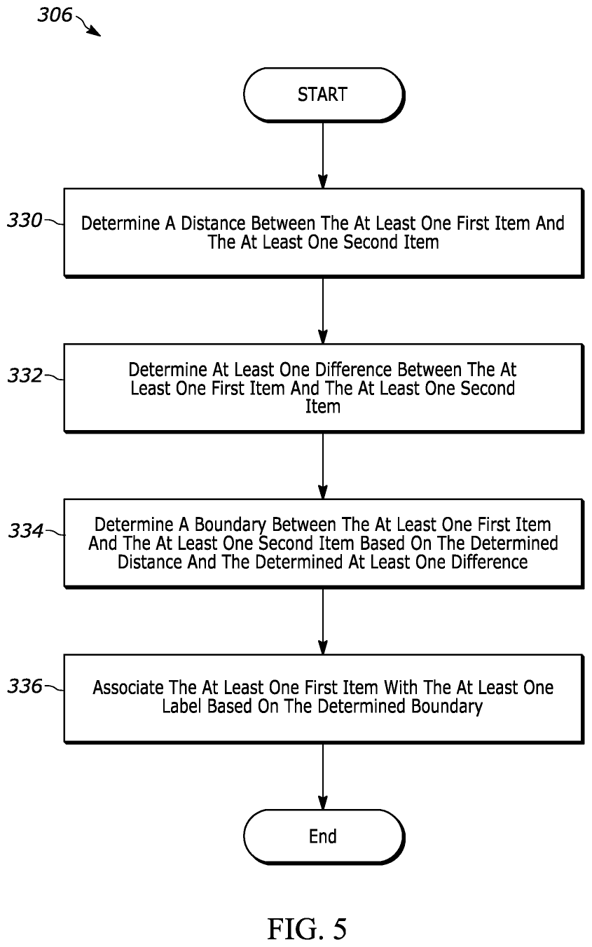

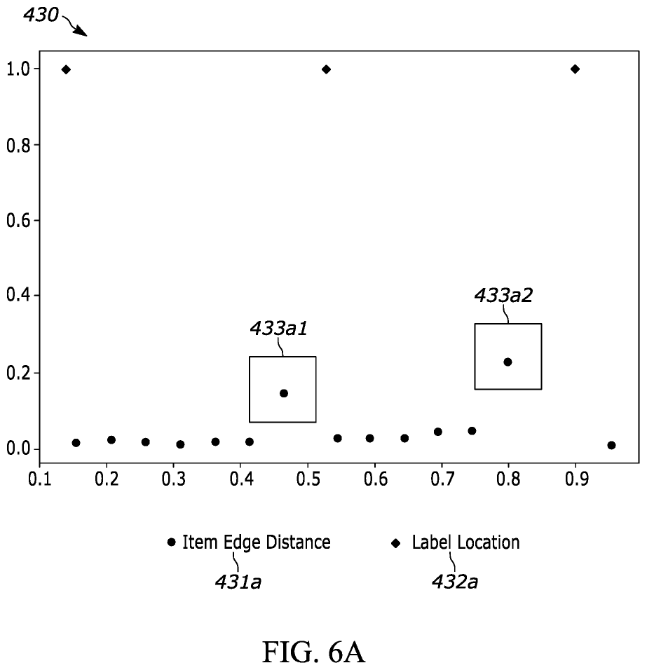

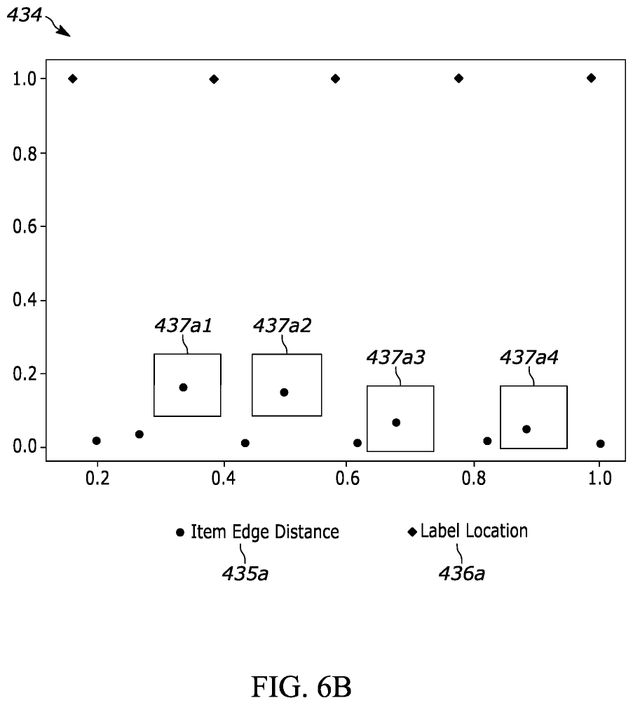

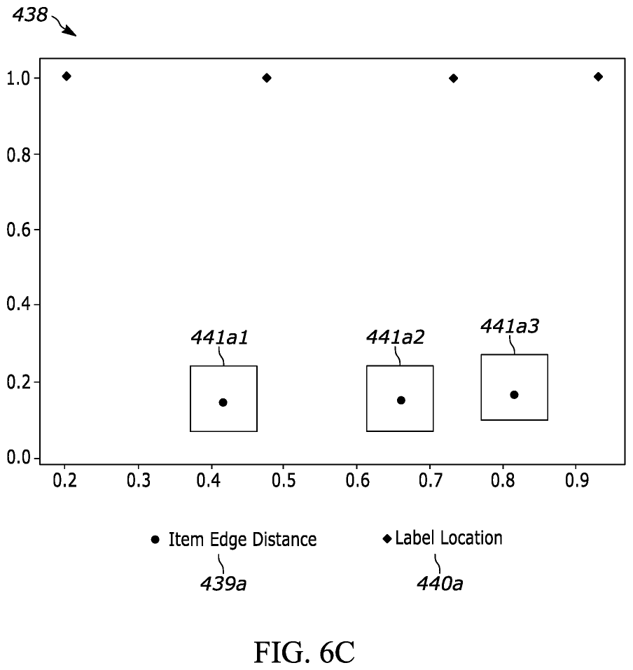

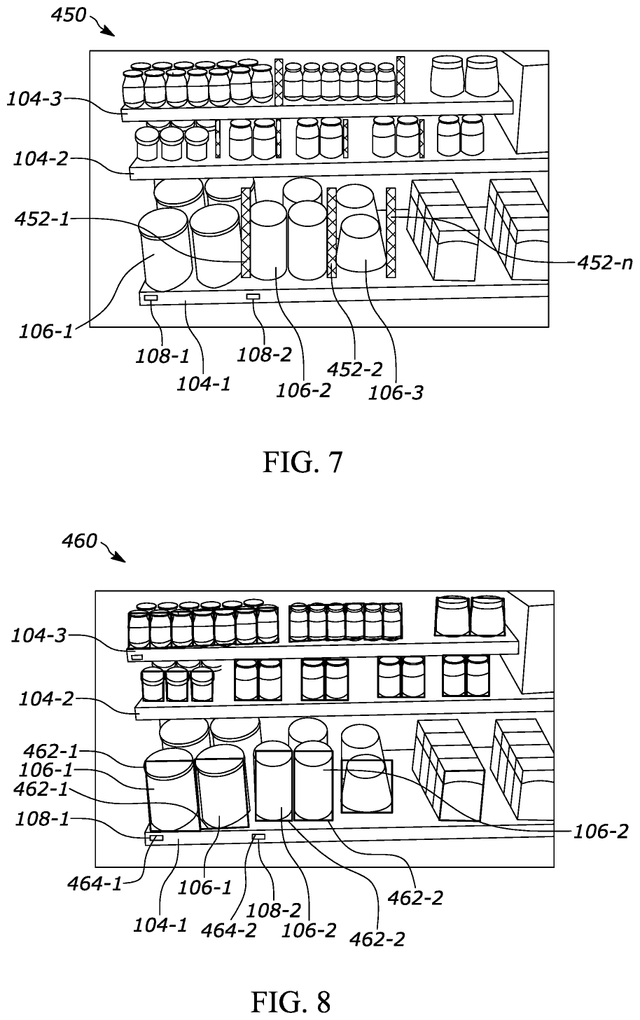

In step 306, the system associates the at least one item 106 with the at least one label 108 based on a boundary between the at least one item 106 (e.g., a first item 106-1) and another item 106 (e.g., a second item 106-2) that is different from the at least one first item 106-1. As described in further detail below, FIG. 5 is a flowchart illustrating step 306 of FIG. 3 in greater detail. Additionally, FIGS. 6A-C are graphs illustrating item and label association carried out by an embodiment of the present disclosure and FIGS. 7 and 8 are diagrams respectively illustrating steps 334 and 336 of FIG. 5.

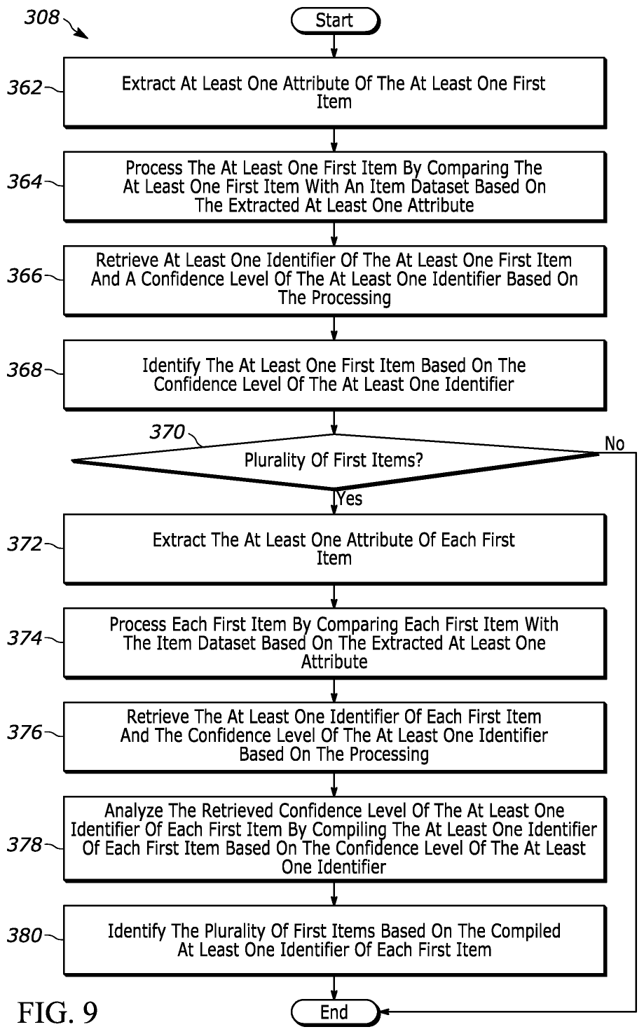

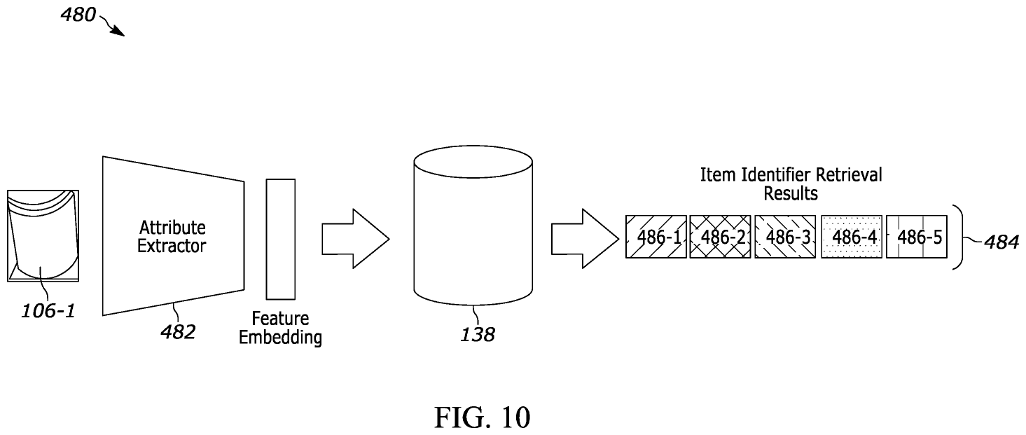

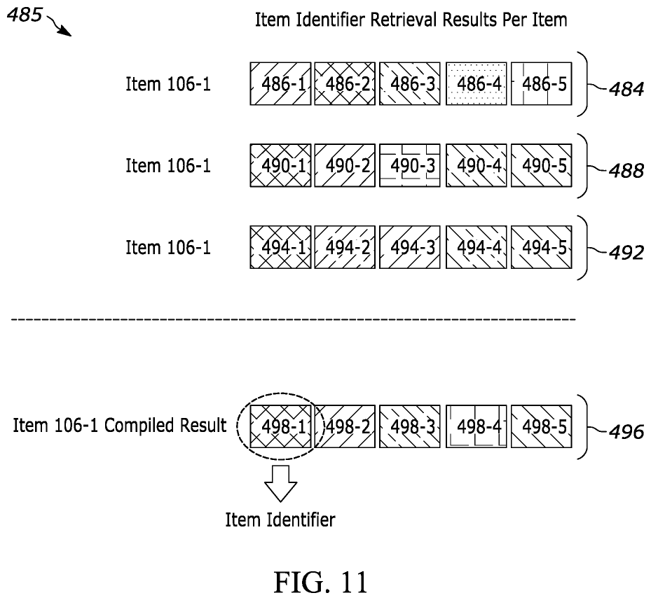

Then, in step 308, the system identifies the at least one item 106 based on at least one attribute (e.g., a feature) of the at least one item 106. For example, the system can utilize a DNN to detect and extract at least one attribute of the at least one item 106 including, but not limited to, a shape, color, pattern, logo, size, width, length, and height of the at least one item 106. As described in further detail below, FIG. 9 is a flowchart illustrating step 308 of FIG. 3 in greater detail. Additionally, FIGS. 10 and 11 are diagrams respectively illustrating item identification carried out by embodiments of the present disclosure.

In step 310, the system determines an area indicative of a position (e.g., on a support surface 104) of the identified at least one item 106 based on the association. The area can be one or more of an aisle, a module, a shelf, a rack, a bay, and a bin. Then, in step 312, the system generates a planogram (e.g., a diagram or a table) based on the association, the identified at least one item 106 and the determined area. The generated planogram can be displayed on the display 124 of the device 116 (e.g., via a user interface). In step 314, the system determines whether the planogram is correct. For example, an associate can confirm whether the displayed planogram on the display 124 is correct. If the system determines the planogram is correct, an associate can transmit the planogram in real-time to a central entity (e.g., corporate headquarters) to optimize the generation of a facility-specific planogram and/or the process ends. Alternatively, if the system determines the planogram is not correct, then the process proceeds to step 316. In step 316, the system modifies the planogram. For example, an associate can select and modify one or more incorrectly classified labels 108 via an input 206 (e.g., a touchscreen and/or barcode scanner) of the device 116. The process then returns to step 312.

FIGS. 4A-B are diagrams respectively illustrating object detection carried out by an embodiment of the present disclosure. FIG. 4A is a diagram 400 illustrating a display module 102 and FIG. 4B is a diagram 420 illustrating object detection of the display module 102 carried out by an embodiment of the present disclosure. As shown in FIG. 4A, the display module 102 includes support surfaces 104-1, 104-2, 104-3, 104-4, 104-5, and 104-6 on which items 106 are positioned thereon and labels 108 are affixed thereto (e.g., on respective edges of the support surfaces 104-1, 104-2, 104-3, 104-4, 104-5, and 104-6). For example, first items 106-1 and second items 106-2 are positioned on the support surface 104-1 and labels 108-1 and 108-2 are affixed to an edge of the support surface 104-1. As mentioned above, the system can utilize a DNN to detect and localize one or more of a support surface 104, an item 106, and a label 108 via a plurality of boundary boxes. As shown in FIG. 4B, the display module 102 includes a plurality of boundary boxes associated with the support surfaces 104, items 106 and labels 108. For example, boundary boxes 422-1 and 422-2 are respectively associated with first and second items 106-1 and 106-2, boundary boxes 424-1 and 424-2 are respectively associated with labels 108-1 and 108-2 and boundary box 426-1 is associated with support surface 104-1.

FIG. 5 is a flowchart illustrating step 306 of FIG. 3 in greater detail. As mentioned above, a planogram can specify an item area 110 (e.g., of a support surface 104) indicative of a position of an item 106. An item area 110 can be determined relative to an alignment of a label 108 (e.g., left, right or center-aligned). This can be problematic because these alignments can be inconsistent across a display module 102. For example, one item area 110 can be left aligned with one label 108 while another item area 110 can be center aligned with another label 108. To address this, the system associates at least one item 106 (e.g., a first item 106-1) with at least one label 108 based on a boundary between the at least one first item 106-1 and another item 106 (e.g., a second item 106-2) that is different from the at least one first item 106-1.

Beginning in step 330, the system determines a distance between the at least one first item 106-1 and the at least one second item 106-2. The distance can be indicative of a void or gap between a position of the at least one first item 106-1 and a position of the at least one second item 106-2. For example, the distance can be a lateral distance between a position of the at least one first item 106-1 and a position of the at least one second item 106-2. In step 332, the system determines at least one difference between the at least one first item 106-1 and the at least one second item 106-2. For example, the at least one difference can be one or more of a shape, color, pattern, logo, size, width, length, and height of each of the at least one first item 106-1 and the at least one second item 106-2. Then, in step 334, the system determines a boundary between the at least one first item 106-1 and the at least one second item 106-2. For example, the system can determine a boundary probability (BP) via Equation 1 as follows:

BP=w×positional gap(item 1,item 2)+(1−w)×difference(item 1,item 2) Equation 1

where w denotes weight and the weight is set based on a condition. For example, if the system determines there is a wide positional gap between the at least one first item 106-1 and the at least one second item 106-2, then the system can weight the positional gap between a position of the at least one first item 106-1 and a position of the at least one second item 106-2 more than the at least one difference between the at least one first item 106-1 and the at least one second item 106-2. In another example, if the system determines there is a narrow positional gap between the at least one first item 106-1 and the at least one second item 106-2, then the system can weight the at least one difference between the at least one first item 106-1 and the at least one second item 106-2 more than the positional gap between a position of the at least one first item 106-1 and a position of the at least one second item 106-2. In addition, a boundary has a maximum boundary probability point. For example, a boundary of a label 108-1 and a label 108-2 denotes a maximum boundary probability point. In step 336, the system associates the at least one first item 106-1 with at least one label 108 based on the determined boundary.

FIGS. 6A-C are graphs illustrating item and label association carried out by an embodiment of the present disclosure. Graph 430 of FIG. 6A corresponds to support surface 104-3 of FIGS. 4A-B, 7 and 8, graph 434 of FIG. 6B corresponds to support surface 104-2 of FIGS. 4A-B, 7 and 8, and graph 438 of FIG. 6C corresponds to support surface 104-1 of FIGS. 4A-B, 7 and 8.

As shown in FIGS. 6A-C, each point 431a, 435a, and 439a is indicative of a type of item 106 or a group of items 106 of the same type, each point 432a, 436a, and 440a is indicative of a location of a label 108, and each square 433a1-2, 437a1-4 and 441a1-3 is indicative of a difference between types of an item 106 or groups thereof (e.g., a first item 106-1 or group of first items 106-1 and a second item 106-2 or group of second items 106-2). For example, as shown in FIG. 6C, square 441a1 is indicative of a difference (e.g., one or more of a shape, color, pattern, logo, size, width, length, and height) between first items 106-1 and second items 106-2 of FIG. 4A-B.

FIG. 7 is a diagram 450 illustrating step 334 of FIG. 5. As shown in FIG. 7, the system can determine a boundary between the first items 106-1 and the second items 106-2. For example, the system can determine a boundary 452-1 between the first items 106-1 and the second items 106-2 based on the determined distance and the determined at least one difference between the first items 106-1 and the second items 106-2. The system can determine a plurality of boundaries 452 (e.g., 452-1, 452-2, and 452-n) between items 106 different from one another. For example and as shown in FIG. 7, the system can determine a boundary 452-2 between second items 106-2 and third items 106-3.

FIG. 8 is a diagram 460 illustrating item and label association carried out by an embodiment of the present disclosure. As shown in FIG. 8, the system can associate the first items 106-1 and label 108-1 based on the boundary 452-1 (as shown in FIG. 7) via respective boundary boxes 462-1 and 464-1 of the same type (e.g., the same color, line type, hatching, or the like). The system can also associate the second items 106-2 and label 108-2 based on the boundary 452-2 (as shown in FIG. 7) via respective boundary boxes 462-2 and 464-2 of the same type.

FIG. 9 is a flowchart illustrating step 308 of FIG. 3 in greater detail. Beginning in step 362, the system extracts at least one attribute of at least one first item 106-1. For example, the system can utilize a DNN to detect and extract at least one attribute of the at least one first item 106-1 including, but not limited to, a shape, color, pattern, logo, size, width, length, and height of the at least one first item 106-1. In step 364, the system can process the at least one first item 106-1 by comparing the at least one first item 106-1 and an item dataset based on the extracted at least one attribute. The item dataset can be stored in the repository 138 and can comprise a plurality of images of items 106. The repository 138 can be proprietary (e.g., comprise images captured by a device 116 of items 106 of a facility) and/or can be universal (e.g., comprise images captured from a plurality of sources).

In step 366, the system can retrieve at least one identifier of the at least one first item 106-1 and a confidence level of the at least one identifier based on the processing. The identifier can be a SKU and/or product code (e.g. a UPC) or the like. For example, the system can retrieve a predetermined number (e.g., an integer value such as 1 or 5) of identifiers and associated confidence levels of the at least one first item 106-1. The confidence level of the at least one identifier can include one or more of a percentage, numerical ranking, gradient color scheme or the like. Then, in step 368, the system can identify the at least one first item 106-1 based on the confidence level of the at least one identifier. For example and shown in FIG. 10, the system can identify the at least one first item 106-1 based on a highest confidence level of a retrieved identifier among a plurality of identifiers.

FIG. 10 is a diagram 480 illustrating item identification carried out by an embodiment of the present disclosure. As shown in FIG. 10, the system can extract an attribute of an item 106-1 via an attribute extractor 482 (e.g., a DNN) and process the at least one first item 106-1 by comparing the at least one first item 106-1 and an item dataset of a repository 138 based on the extracted at least one attribute to yield a result 484 indicative of at least one identifier and an associated confidence level of the at least one identifier. For example, the result 484 includes identifiers 486-1, 486-2, 486-3, 486-4 and 486-5 ranked in descending order (from left to right) based on a gradient color scheme where a warmer/lighter color (e.g., yellow) is indicative of a higher confidence level than a cooler/darker color (e.g., blue). As such, the system can identify the at least one first item 106-1 based on the identifier 486-1 since the identifier 486-1 has a highest confidence level among the plurality of identifiers. If the confidence level of the at least one identifier having a highest confidence level is below a threshold, the system can prompt an associate to provide an identifier of the at least one item 106-1.

Returning to FIG. 9, in step 370, the system determines whether there is an additional at least one first item 106-1. If the system determines there is not an additional first item 106-1, then the process ends. Alternatively, if the system determines there is an additional at least one first item 106-1, then the process proceeds to step 372. In step 372, the system extracts at least one attribute of each first item 106-1. As mentioned above, the system can utilize a DNN to detect and extract at least one attribute of each first item 106-1 including, but not limited to, a shape, color, pattern, logo, size, width, length, and height of each first item 106-1. Then, in step 374, the system can process each first item 106-1 by comparing each first item 106-1 and the item dataset based on the extracted at least one attribute of each first item 106-1. In step 376, the system can retrieve at least one identifier of each first item 106-1 and a confidence level of the at least one identifier based on the processing. The identifier can be a SKU and/or product code (e.g. a UPC) or the like. In step 378, the system can analyze the retrieved confidence level of the at least one identifier of each first item 106-1 by compiling the at least one identifier of each first item 106-1 based on the confidence level of the at least one identifier. In step 380, the system can identify the plurality of first items 106-1 based on the compiled at least one identifier of each first item 106-1. For example and shown in FIG. 11, the system can identify the plurality of first items 106-1 based on a compiled highest confidence level of a retrieved identifier among a plurality of identifiers.

FIG. 11 is a diagram 485 illustrating item identification carried out by an embodiment of the present disclosure. As shown in FIG. 11, the system can analyze a retrieved confidence level of at least one identifier of each first item 106-1 by compiling the at least one identifier of each first item 106-1 based on a confidence level of the at least one identifier. For example and as shown in FIG. 10, the compiled result 496 of item 106-1 is based on a compilation of result 484 (including identifiers 486-1, 486-2, 486-3, 486-4 and 486-5), result 488 (including identifiers 490-1, 490-2, 490-3, 490-4, and 490-5), and result 492 (including identifiers 494-1, 494-2, 494-3, 494-4, and 494-5). The compiled result 496 includes identifiers 498-1, 498-2, 498-3, 498-4, and 498-5 ranked in descending order (from left to right) based on the respective identifiers of results 484, 488 and 492 such that identifier 498-1 of result 496 is indicative of a highest confidence level of a retrieved identifier among the plurality of identifiers. As such, the system can identify the at least one first item 106-1 based on the identifier 498-1. As mentioned above, the system can utilize a gradient color scheme where a warmer/lighter color (e.g., yellow) is indicative of a higher confidence level than a cooler/darker color (e.g., blue). If the confidence level of the at least one identifier having a highest confidence level is below a threshold, the system can prompt an associate to provide an identifier of the at least one item 106-1.

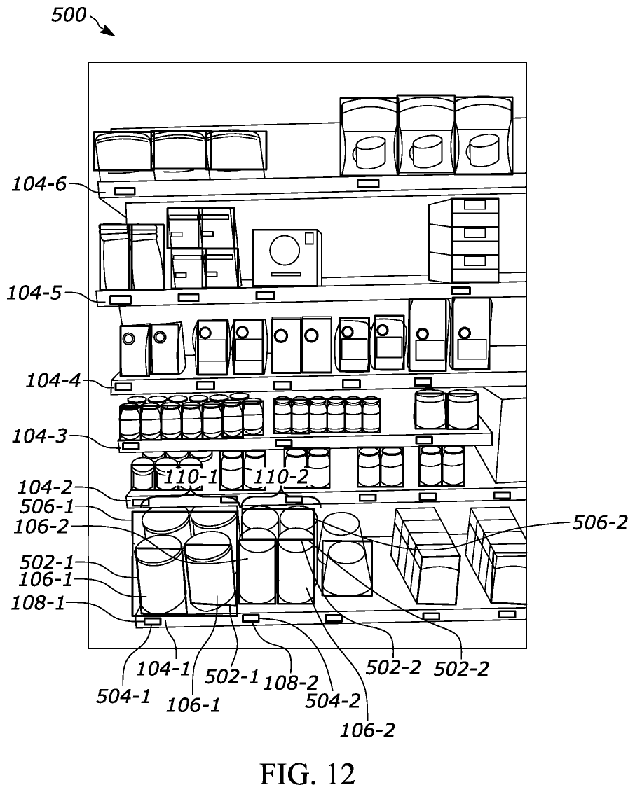

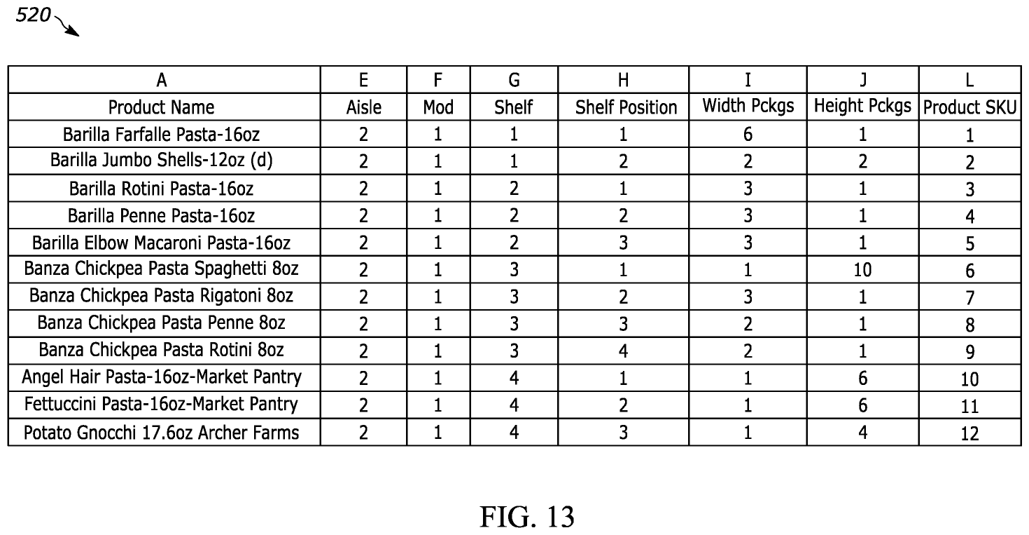

FIG. 12 is a diagram 500 illustrating a planogram generated by an embodiment of the present disclosure. As shown in FIG. 12, the system can generate a planogram based on an association between an item 106 and a label 108, an identification of an item 106 and a determined item area 110 indicative of a position of the identified item 106. For example and as shown in FIG. 12, the system can associate the first items 106-1, label 108-1 and item area 110-1 via respective boundary boxes 502-1, 504-1 and 506-1 of the same type (e.g., the same color, line type, hatching, or the like). The system can also associate the second items 106-2, label 108-2 and item area 110-2 via respective boundary boxes 502-2, 504-2 and 506-2 of the same type. The generated planogram can be displayed on the display 124 of the device 116 (e.g., via a user interface). An associate can confirm whether the displayed planogram on the display 124 is correct. If the planogram is correct, an associate can transmit the planogram in real-time to a central entity (e.g., corporate headquarters) to optimize the generation of a facility-specific planogram. Alternatively, if the planogram is not correct, an associate can select and modify one or more incorrectly classified labels 108 via an input 206 (e.g., a touchscreen and/or barcode scanner) of the device 116. FIG. 13 is a table 520 illustrating a planogram generated by an embodiment of the present disclosure.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed:

1. A method for planogram generation, comprising:
detecting at least one first item and at least one label present in a captured image;
associating the at least one first item with the at least one label based on a boundary between the at least one first item and at least one second item different from the at least one first item;
identifying the at least one first item based on at least one attribute of the at least one first item;
determining an area indicative of a position of the identified at least one first item based on the association; and
generating a planogram based on the association, the identified at least one first item and the area.

2. The method of claim 1, wherein associating the at least one first item with the at least one label based on the boundary between the at least one first item and the at least one second item different from the at least one first item comprises:
determining a distance between the at least one first item and the at least one second item;
determining at least one difference between the at least one first item and the at least one second item;
determining the boundary between the at least one first item and the at least one second item based on the determined distance and the determined at least one difference; and
associating the at least one first item with the at least one label based on the determined boundary.

3. The method of claim 1, wherein identifying the at least one first item based on the at least one attribute of the at least one first item comprises:
extracting the at least one attribute of the at least one first item;
processing the at least one first item by comparing the at least one first item and an item dataset based on the extracted at least one attribute;
retrieving at least one identifier of the at least one first item and a confidence level of the at least one identifier based on the processing; and
identifying the at least one first item based on the confidence level of the at least one identifier.

4. The method of claim 3, further comprising:
extracting the at least one attribute of each first item;
processing each first item by comparing each first item with the item dataset based on the extracted at least one attribute;
retrieving the at least one identifier of each first item and the confidence level of the at least one identifier based on the processing;
analyzing the retrieved confidence level of the at least one identifier of each first item by compiling the at least one identifier of each first item based on the confidence level of the at least one identifier; and
identifying the plurality of first items based on the compiled at least one identifier of each first item.

5. The method of claim 1, further comprising
displaying, on a user interface, the generated planogram for a user; and
transmitting the planogram.

6. The method of claim 1, wherein
the area is one or more of an aisle, a module, a shelf, a rack, a bay, and a bin, and
the at least one attribute is one or more of a shape, color, pattern, logo, size, width, length, and height of the at least one item.

7. The method of claim 4, wherein the at least one identifier is one or more of a stock keeping unit (SKU) and a Universal Product Code (UPC).

8. A device for planogram generation, comprising,
an imaging assembly configured to capture an image featuring a plurality of items;
one or more processors; and
a non-transitory computer-readable memory coupled to the imaging assembly and the one or more processors, the memory storing instructions thereon that, when executed by the one or more processors, cause the one or more processors to:
detect at least one first item and at least one label present in a captured image;
associate the at least one first item with the at least one label based on a boundary between the at least one first item and at least one second item different from the at least one first item;
identify the at least one first item based on at least one attribute of the at least one first item;
determine an area indicative of a position of the identified at least one first item based on the association; and
generate a planogram based on the association, the identified at least one first item and the area.

9. The device of claim 8, wherein the instructions, when executed, cause the one or more processors to associate the at least one first item with the at least one label based on the boundary between the at least one first item and the at least one second item different from the at least one first item by:
determining a distance between the at least one first item and the at least one second item;
determining at least one difference between the at least one first item and the at least one second item;
determining the boundary between the at least one first item and the at least one second item based on the determined distance and the determined at least one difference; and
associating the at least one first item with the at least one label based on the determined boundary.

10. The device of claim 8, wherein the instructions, when executed, cause the one or more processors to identify the at least one first item based on the at least one attribute of the at least one first item by:
extracting the at least one attribute of the at least one first item;
processing the at least one first item by comparing the at least one first item and an item dataset based on the extracted at least one attribute;
retrieving at least one identifier of the at least one first item and a confidence level of the at least one identifier based on the processing; and
identifying the at least one first item based on the confidence level of the at least one identifier.

11. The device of claim 10, wherein the instructions, when executed, further cause the one or more processors to:
extract the at least one attribute of each first item;
process each first item by comparing each first item with the item dataset based on the extracted at least one attribute;
retrieve the at least one identifier of each first item and the confidence level of the at least one identifier based on the processing;
analyze the retrieved confidence level of the at least one identifier of each first item by compiling the at least one identifier of each first item based on the confidence level of the at least one identifier; and
identify the plurality of first items based on the compiled at least one identifier of each first item.

12. The device of claim 8, wherein the instructions, when executed, further cause the one or more processors to:
display, on a user interface, the generated planogram for a user; and
transmit the planogram.

13. The device of claim 8, wherein
the area is one or more of an aisle, a module, a shelf, a rack, a bay, and a bin, and
the at least one attribute is one or more of a shape, color, pattern, logo, size, width, length, and height of the at least one item.

14. The device of claim 11, wherein the at least one identifier is one or more of a stock keeping unit (SKU) and a Universal Product Code (UPC).

15. A tangible machine-readable medium comprising instructions for planogram generation that, when executed, cause a machine to at least:
detect at least one first item and at least one label present in a captured image;
associate the at least one first item with the at least one label based on a boundary between the at least one first item and at least one second item different from the at least one first item;
identify the at least one first item based on at least one attribute of the at least one first item;
determine an area indicative of a position of the identified at least one first item based on the association; and
generate a planogram based on the association, the identified at least one first item and the area.

16. The tangible machine-readable medium of claim 15, wherein the instructions, when executed, cause the machine to associate the at least one first item with the at least one label based on the boundary between the at least one first item and the at least one second item different from the at least one first item by:
determining a distance between the at least one first item and the at least one second item;
determining at least one difference between the at least one first item and the at least one second item;
determining the boundary between the at least one first item and the at least one second item based on the determined distance and the determined at least one difference; and
associating the at least one first item with the at least one label based on the determined boundary.

17. The tangible machine-readable medium of claim 15, wherein the instructions, when executed, cause the machine to identify the at least one first item based on the at least one attribute of the at least one first item by:
extracting the at least one attribute of the at least one first item;
processing the at least one first item by comparing the at least one first item and an item dataset based on the extracted at least one attribute;
retrieving at least one identifier of the at least one first item and a confidence level of the at least one identifier based on the processing; and
identifying the at least one first item based on the confidence level of the at least one identifier.

18. The tangible machine-readable medium of claim 17, wherein the instructions, when executed, further cause the machine to:
extract the at least one attribute of each first item;
process each first item by comparing each first item with the item dataset based on the extracted at least one attribute;
retrieve the at least one identifier of each first item and the confidence level of the at least one identifier based on the processing;
analyze the retrieved confidence level of the at least one identifier of each first item by compiling the at least one identifier of each first item based on the confidence level of the at least one identifier; and
identify the plurality of first items based on the compiled at least one identifier of each first item.

19. The tangible machine-readable medium of claim 15, wherein the instructions, when executed, further cause the machine to:
display, on a user interface, the generated planogram for a user; and
transmit the generated planogram.

20. The tangible machine-readable medium of claim 15, wherein
the area is one or more of an aisle, a module, a shelf, a rack, a bay, and a bin, and
the at least one attribute is one or more of a shape, color, pattern, logo, size, width, length, and height of the at least one item.

21. The tangible machine-readable medium of claim 18, wherein the at least one identifier is one or more of a stock keeping unit (SKU) and a Universal Product Code (UPC).
